(19) United States
(12) Patent Application Publication
(10) Pub. No.: US 2006/0193375 A1
(43) Pub. Date: Aug. 31, 2006

(54) Transceiver for zigbee and bluetooth communications

(76) Inventor: U. Sang Lee, Suwon (KR)

Correspondence Address: MCDERMOTT WILL & EMERY LLP, 600 13TH STREET, N.W., WASHINGTON, DC, 20005-3096, US

(21) Appl. No.: 11/326,300

(22) Filed: Jan. 6, 2006

(30) Foreign Application Priority Data
Feb. 28, 2005 (KR) 10-2005-0016527

(51) Int. Cl. H04L 5/16; H04L 27/10

(52) U.S. Cl. 375/219; 375/272

(57) ABSTRACT

The invention provides a transceiver for Zigbee and Bluetooth communications integrating a Zigbee transceiver and a Bluetooth transceiver. The transceiver includes an RF processor 110, a variable bandpass filter 120, an FSK modulator/demodulator 130, a memory 140, a baseband processor 150, a main controller 160, and a channel selection/frequency hopping controller 170. The invention integrates the Zigbee transceiver and the Bluetooth transceiver so as to partially make common use of a higher layer application and a physical layer of the Zigbee transceiver and the Bluetooth transceiver. As a result, the invention has the advantage of functioning as a transceiver for Zigbee and Bluetooth communications, without causing a significant increase in size and unit price.

### CLAIM OF PRIORITY

This application claims the benefit of Korean Patent Application No. 2005-16527 filed on Feb. 28, 2005, in the Korean Intellectual Property Office, the disclosure of which is incorporated herein by reference.

### BACKGROUND OF THE INVENTION

1. Field of the Invention

The present invention relates to a transceiver for Zigbee and Bluetooth communications employed in a telecommunication system, more particularly to a transceiver for Zigbee and Bluetooth communications incorporating a Zigbee transceiver and a Bluetooth transceiver.

2. Description of the Related Art

Generally, a standardized wireless network is categorized into Wide Area Network (WAN) (IEEE 802.20), Metropolitan Area Network (MAN) (IEEE 802.16), L ocal Area Network (LAN) (IEEE 802.11) and Personal Area Network (PAN) (IEEE 802.15).

A key solution of Wireless Personal Area Network (PAN) includes Zigbee and Bluetooth which have been standardized via IEEE 802.15, the same wireless PAN standardization group. Accordingly, Zigbee and Bluetooth are greatly similar in a physical layer and an MAC layer, and have similar applications in a higher layer.

Despite these similarities, a Zigbee transceiver and a Bluetooth transceiver have been developed and manufactured independently as shown in FIGS. 1 and 2.

FIG. 1 shows a configuration of a conventional Zigbee transceiver. The Zigbee transceiver shown in FIG. 1 includes an RF processor 11 for converting an RF reception signal corresponding to a channel selected out of 2.4 GHz RF reception signals into an IF reception signal, and converting an IF transmission signal into an RF transmission signal of the selected channel; an MSK modulator/demodulator 12 for demodulating the IF reception signal from the RF processor 11 into a baseband reception signal by Minimum Shift Keying (MSK), and modulating a baseband transmission signal into the IF transmission signal by MSK to output to the RF processor 11; a baseband processor 14 for converting the baseband reception signal MSK-demodulated by the MSK modulator/demodulator 12 into a digital reception signal by bandpass processing, and converting the digital transmission signal into the baseband transmission signal by bandpass processing to output to the MSK modulator/demodulator 12; a memory 15 storing a firmware to control Zigbee transmission/reception, a controller 16 for executing Zigbee transmission/reception control including channel selection control by executing the firmware of the memory 15, and receiving the digital reception signal from the baseband processor 14 and providing the digital transmission signal to the baseband processor 14; and a channel selector for selecting an RF channel of the RF processor 11 under the control of the controller 16.

Zigbee using 2.4 GHz frequency includes 16 channels, of which one is selected to perform transmission/reception.

FIG. 2 shows a configuration of a conventional Bluetooth transceiver. The Bluetooth transceiver shown in FIG. 2 includes an RF processor 21 for converting an RF reception signal of 2.4 Hz RF reception signals into an IF reception signal under frequency hopping control, and converting an IF transmission signal into an RF transmission signal under frequency hopping control; an FSK modulator/demodulator 22 for FSK-demodulating an IF transmission signal from the RF processor 21 into a baseband reception signal and FSK-modulating a baseband transmission signal into the IF transmission signal in accordance with pre-set hopping frequency to output to the RF processor 21; a baseband processor 24 for converting the baseband reception signal FSK-demodulated by the FSK modulator/demodulator 22 into a digital reception signal by bandpass processing, and converting a digital transmission signal into the baseband transmission signal by bandpass processing to output to the FSK modulator/demodulator 22; a memory 25 storing a firmware to control Bluetooth transmission/reception; a controller 26 for controlling Bluetooth transmission/reception by executing the firmware of the memory 25, receiving the digital reception signal from the baseband processor 24 and providing the digital transmission signal to the baseband processor 24, and a hopping frequency controller 17 for controlling hopping frequency of the RF processor 21 based on hopping frequency from the FSK modulator/demodulator 22.

A Bluetooth employing 2.4 GHz frequency adopts FSK modulation and demodulation, and thus for proper modulation and demodulation, it should be executed in accordance with a preset hopping frequency.

The conventional Zigbee transceiver and Bluetooth transceiver have been independently designed and produced. However due to advancement in telecommunication technology and consumers' needs for multifunctionality these days, research and development regarding integration of the Zigbee and Bluetooth transceivers have been under way.

But, a simple integration of the conventional Zigbee transceiver and Bluetooth transceiver almost doubles size and price unit.

Therefore there has arisen a need to incorporate the Zigbee transceiver and the Bluetooth transceiver while not significantly increasing size or price unit considering similarities and common features.

### SUMMARY OF THE INVENTION

The present invention has been made to solve the foregoing problems of the prior art and it is therefore an object of the present invention to provide a transceiver for Zigbee and Bluetooth communications.

It is another object of the invention to provide a transceiver for Zigbee and Bluetooth communications capable of partially making common use of an higher layer application and a physical layer of the Zigbee transceiver and Bluetooth transceiver.

According to an aspect of the invention for realizing the object, there is provided a transceiver for Zigbee and Bluetooth communications, the transceiver comprising: an RF processor for converting an RF signal received via antenna into an IF reception signal under channel selection/frequency hopping control; a variable bandpass filter for passing the IF reception signal from the RF processor through a first passband or a second passband, which is pre-set under filtering band control; an FSK modulator/demodulator for FSK-demodulating the IF reception signal from the variable bandpass filter into a baseband reception signal; a memory storing a first firmware and a reference table for Zigbee operation mode, and a second firmware for Bluetooth operation mode; a baseband processor for converting the baseband reception signal from the FSK modulator/demodulator into a digital reception signal in response to the memory executing a corresponding one of the firmwares according to a selected operation mode; a main controller for executing signal transmission/reception control for the selected operation mode including the filtering band control and RF operation control, in response to the memory executing a corresponding one of the firmwares according to the selected operation mode, and processing the digital reception signal from the baseband processor and a digital transmission signal at a higher layer; and a channel selection/frequency hopping controller for executing channel selection control or frequency hopping control over the RF processor in response to the RF operation control by the main controller, whereby the baseband processor converts the digital transmission signal from the main controller into a baseband transmission signal, the FSK modulator/demodulator converts the baseband transmission signal from the baseband processor into an IF transmission signal, the variable bandpass filter passes the IF transmission signal from the FSK modulator/demodulator through the pre-set passband, and the RF processor converts the IF transmission signal from the variable bandpass filter into an RF transmission signal to output via the antenna.

The RF processor may comprise: a frequency synthesizer for executing channel selection or frequency hopping under the control of the channel selection/frequency hopping controller; a receiving processor for converting the RF reception signal corresponding to a channel selected by the frequency synthesizer into the IF reception signal in Zigbee operation mode, and converting the RF reception signal into the IF reception signal according to frequency hopping by the frequency synthesizer in Bluetooth operation mode; and a transmitting processor for converting the IF transmission signal from the variable bandpass filter into the RF transmission signal corresponding to the channel selected by the frequency synthesizer, and converting the IF transmission signal from the variable bandpass filter into the RF transmission signal according to frequency hopping by the frequency synthesizer in Bluetooth operation mode.

The first passband is set at 5 MHz as a channel width of Zigbee, and the second passband is set at 1 MHz as a channel width of Bluetooth.

The baseband processor may comprise: a baseband controller for receiving operation mode selection information from the main controller and executing a corresponding one of the firmwares of the memory according to the selected operation mode to control transmitting or receiving operation corresponding to the selected mode; a Zigbee baseband processor operating under the control of the baseband controller; and a Bluetooth baseband processor operating under the control of the baseband controller.

The channel selection/frequency hopping controller may comprise: a channel selection controller for controlling Zigbee channel selection control over the RF processor in Zigbee operation mode, under the RF operation control by the main controller; and a frequency hopping controller for controlling frequency hopping in the RF processor in response to frequency hopping of the FSK modulator/demodulator in Bluetooth operation mode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration of a conventional transceiver for Zigbee;

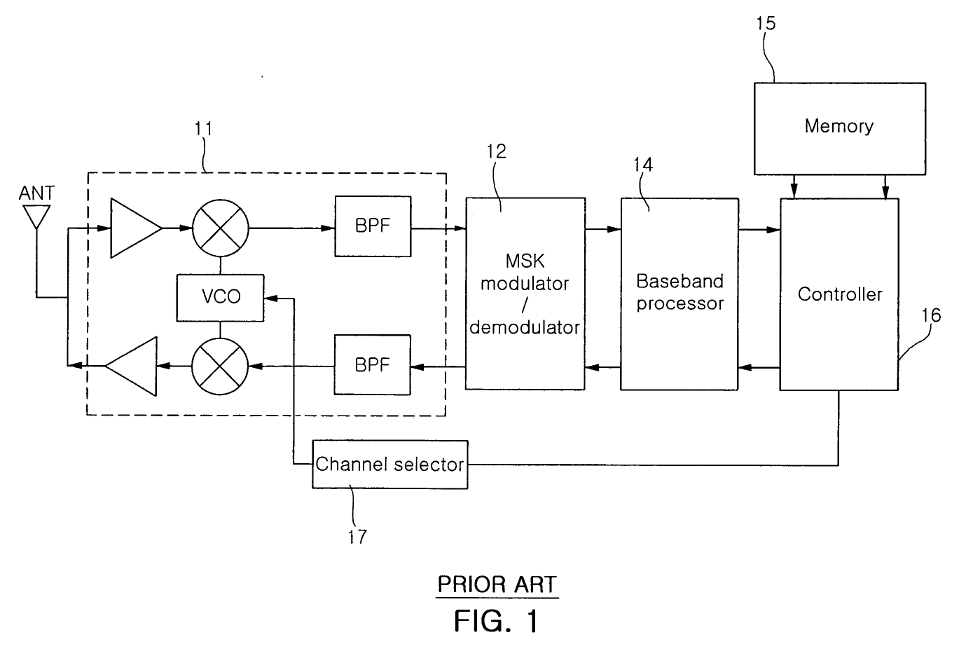

FIG. 2 is a configuration of a conventional transceiver for Bluetooth;

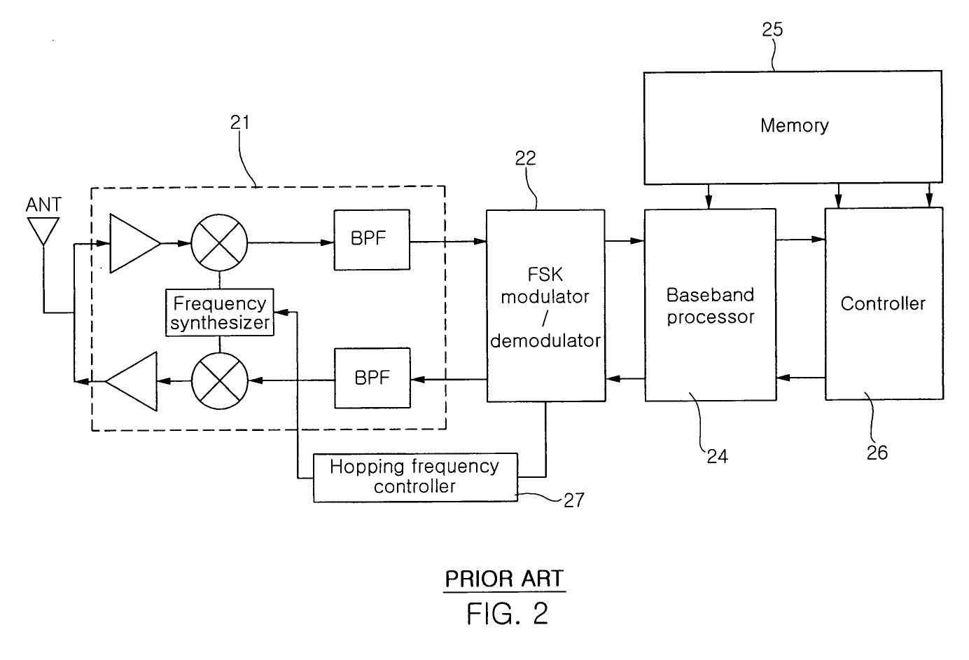

FIG. 3 is a configuration of a transceiver for Zigbee and Bluetooth communications of the invention;

FIG. 4 is an example illustrating a variable bandpass filter of FIG. 3;

FIG. 5 is an internal configuration of a baseband processor of FIG. 3;

FIG. 6 is a flowchart of signal processing in Zigbee operation mode of the invention; and

FIG. 7 is a flowchart of signal processing in Bluetooth operation mode of the invention.

### DETAILED DESCRIPTION OF THE PREFERRED EMBODIMENT

Preferred embodiments of the present invention will now be described in detail with reference to the accompanying drawings, in which the reference numerals are used throughout the different drawings to designate the same or similar component.

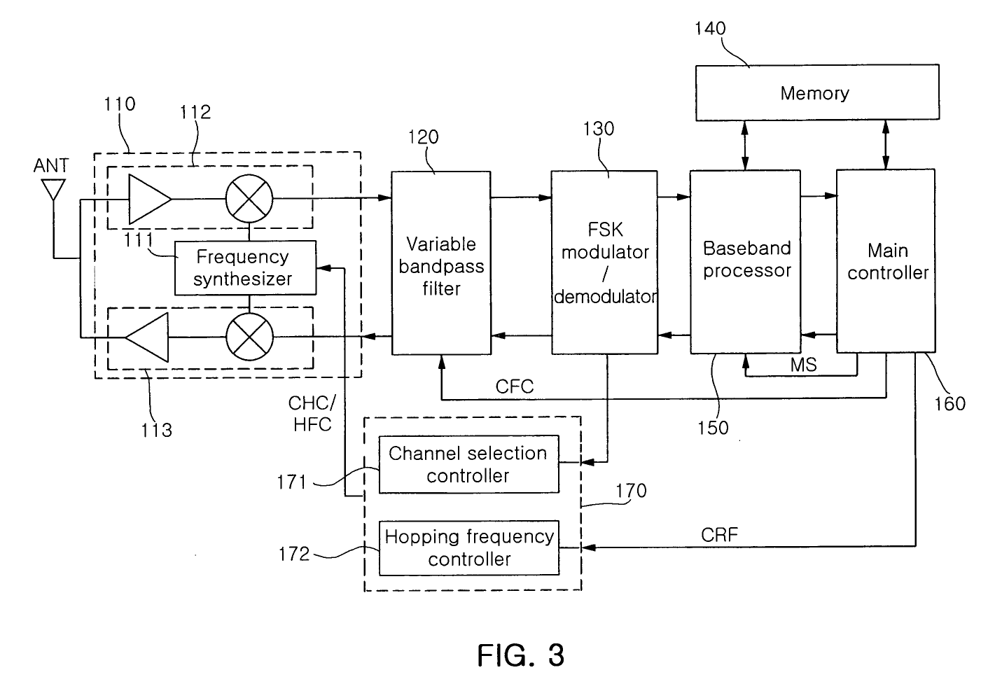

FIG. 3 shows a configuration of a transceiver for Zigbee and Bluetooth communications of the invention.

Referring to FIG. 3, the transceiver for Zigbee and Bluetooth communications of the invention includes an RF processor 110, a variable bandpass filter 120, an FSK modulator/demodulator 130, a memory 140, a baseband processor 150, a main controller 160 and a channel selection/frequency hopping controller 170.

The RF processor converts an RF signal received via antenna into an IF reception signal under the control of the channel selection/frequency hopping controller 170 to output to the variable bandpass filter 120, and converts an IF transmission signal from the variable bandpass filter 120 into an RF transmission signal to output via the antenna ANT.

The variable bandpass filter 120 passes the IF reception signal from the RF processor 110 through a first or a second bandpass, which is pre-set under filtering band control of the main controller 160 to output to the FSK modulator/demodulator 130, and passes the IF transmission signal from the FSK modulator/demodulator 130 through the pre-set passband to output to the RF processor 110

The FSK modulator/demodulator 130 FSK-demodulates the IF reception signal from the variable bandpass filter 120 into a baseband reception signal, and converts a baseband transmission signal from the baseband processor 150 into the IF transmission signal.

The memory 140 stores a first firmware for Zigbee operation mode, a reference table and a second firmware for Bluetooth operation mode required by the baseband processor 150 and the main controller 160, respectively.

The baseband processor 150 converts the baseband reception signal from the FSK modulator/demodulator 130 into a digital reception signal, and converts the digital transmission signal from the main controller 160 into the baseband transmission signal in response to the memory executing a corresponding one of the firmwares according to a selected operation mode.

The main controller 160 executes signal transmission/reception control for the selected operation mode including filtering band control over the variable baseband filter 120 and RF operation control over the channel selection/frequency hopping controller 170, in response to the memory executing a corresponding one of the firmwares according to the selected operation mode, and processing the digital reception signal from the baseband processor 150 and the digital transmission signal at a higher layer.

The channel selection/frequency hopping controller 170 executing channel selection or frequency hopping control over the RF processor 110 in response to the RF operation control by the main controller 160.

In addition, the RF processor 110 includes a frequency synthesizer for executing channel selection or frequency hopping under the control of the channel selection/frequency hopping controller 170; a receiving processor 112 for converting the RF reception signal corresponding to a channel selected by the frequency synthesizer 111 into the IF reception signal in Zigbee operation mode, and converting the RF reception signal into the IF reception signal according to frequency hopping by the frequency synthesizer 111 in Bluetooth operation mode; and a transmitting processor 113 for converting the IF transmission signal from the variable bandpass filter 120 into the RF transmission signal corresponding to the channel selected by the frequency synthesizer in Zigbee operation mode, and converting the IF transmission signal from the variable bandpass filter 120 into the RF transmission signal according to frequency hopping by the frequency synthesizer 111 in Bluetooth operation mode.

Furthermore, the variable bandpass filter 120 can be implemented with an analogue filter such as a reconfigurable filter which enables a filter to constitute first and second passbands, or with a digital filter such as Finite Impulse Response (FIR) filter or Infinite Impulse Response (IIR) filter.

In implementing the variable bandpass filter 120 with the digital filter, the variable bandpass filter 120 includes an A/D block for A/D converting reception signals from the RF processor 11 and a D/A block for D/A converting transmission signals.

The first firmware stored in the memory 140 performs baseband-processing and data-processing in a higher layer in accordance with Zigbee communication protocol (IEEE 802.15.4), whereas the second firmware performs baseband-processing and data-processing at a higher layer in accordance with Bluetooth communication protocol (IEEE 802.15.1).

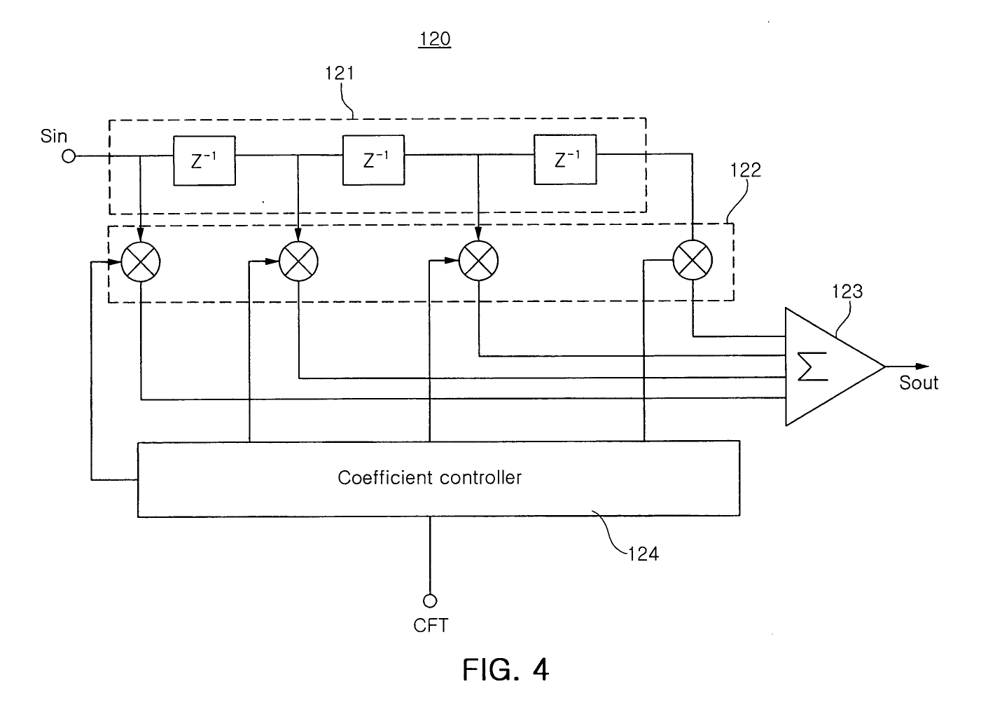

For example, as shown in FIG. 4, the variable bandpass filter 120 can be configured with FIR filter.

Referring to FIG. 4, the variable bandpass filter 120 includes a delayer 121, a multiplier 122, a summer 123 and a coefficient controller 124. The number of steps in the delayer 121 and the multiplier 122 can be adequately selected in accordance with the filter precision and system environment.

The delayer 121 includes plural delayer elements for delaying input signals in series. The multiplier 122 includes plural multiplier elements for multiplying each signal from the delayer elements of the delayer 121 by coefficients from the coefficient controller 124. The summer 123 includes an adder for summing signals from the multiplier elements of the multiplier 122 to output. The coefficient controller 124 sets different coefficients for Zigbee and Bluetooth according to the filtering band control (CFT), and provides the same to the summer 123. The variable bandpass filter implemented with FIR filter sets different coefficients for Zigbee and Bluetooth so as to easily determine a passband.

In the variable bandpass filter 120, the first passband is set at 5 MHz as a channel width of Zigbee and the second passband is set at 1 MHz as a channel width of Bluetooth.

In implementing the bandpass filter with a digital filter having this type of structure, a filter structure shown in FIG. 4 should be provided for transmission and reception.

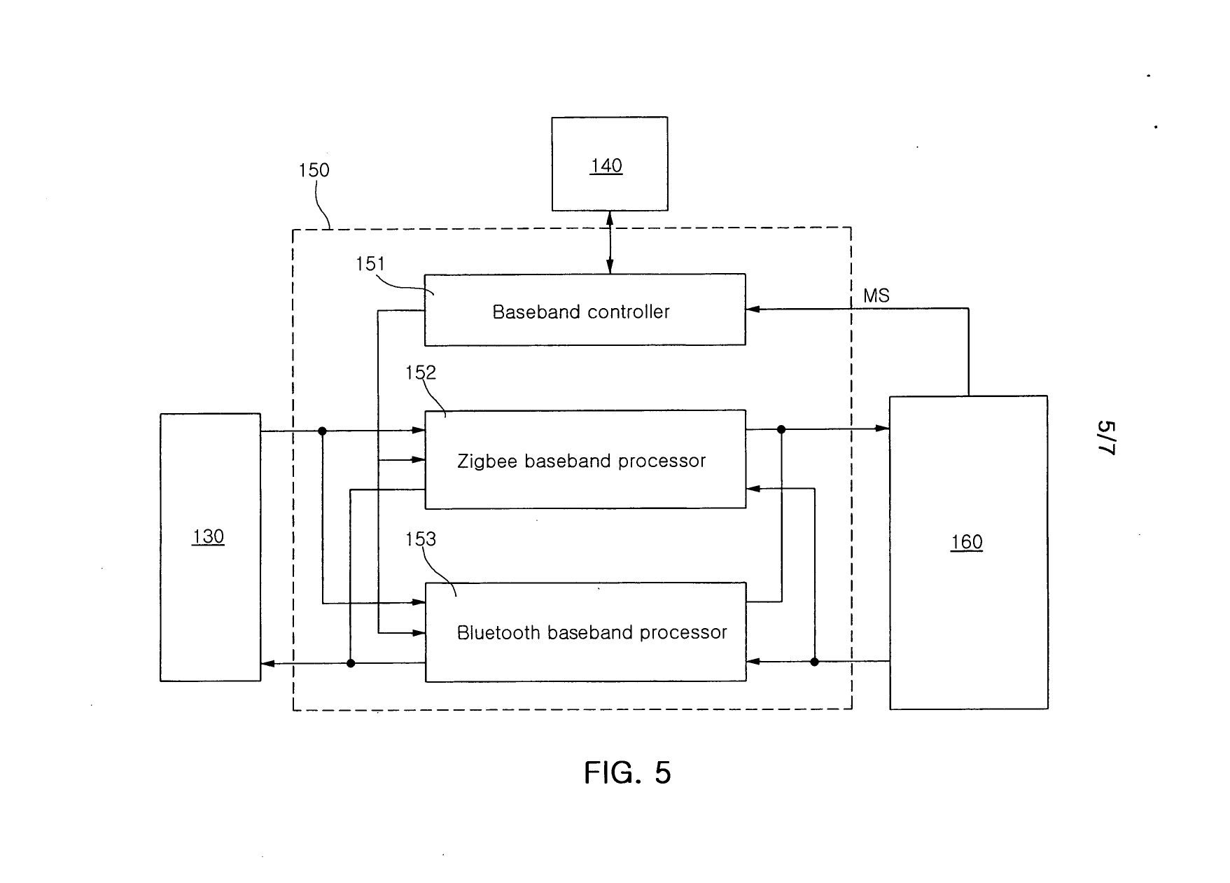

FIG. 5 shows an internal configuration of the baseband processor of FIG. 3. Referring to FIG. 5, the baseband processor 150 includes a baseband controller 151 for receiving operation mode selection information from the main controller 160, and executing a corresponding one of the firmwares of the memory 140 according to the selected operation mode to control transmitting or receiving operation corresponding to the selected mode; a Zigbee baseband processor 152 operating under the control of the baseband controller 151; and a Bluetooth baseband processor 153 operating under the control of the baseband controller 151.

Furthermore, as shown in FIG. 3, the channel selection/frequency hopping controller 170 includes a channel selection controller 171 for controlling Zigbee channel selection over the RF processor 110 in Zigbee operation mode, under the RF operation control by the main controller 160; and a frequency hopping controller 172 for controlling frequency hopping over the RF processor 110 in response to frequency hopping of the FSK modulator/demodulator 130 in Bluetooth operation mode.

The operation and effects of the invention will be explained in detail hereunder with reference to the accompanying drawings.

The transceiver for Zigbee and Bluetooth communications of the invention executes Zigbee operation mode or Bluetooth operation mode according to selection of operation mode. The transceiver of the invention for performing transmission and reception by operation mode, as shown in FIG. 3, includes an RF processor 110, a variable bandpass filter 120, an FSK modulator/demodulator 130, a memory 140, a baseband processor 150, a main controller 160 and a channel selection/frequency hopping controller 170.

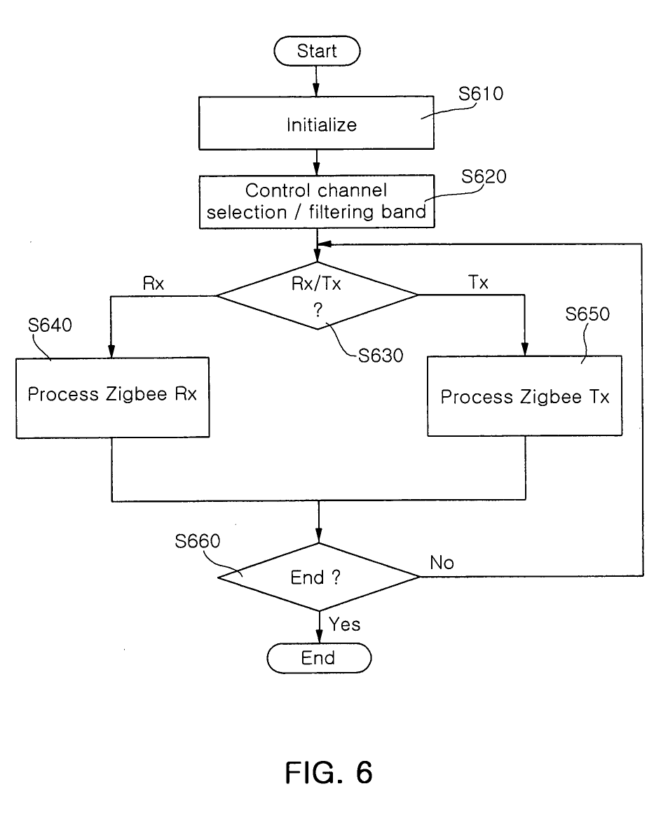

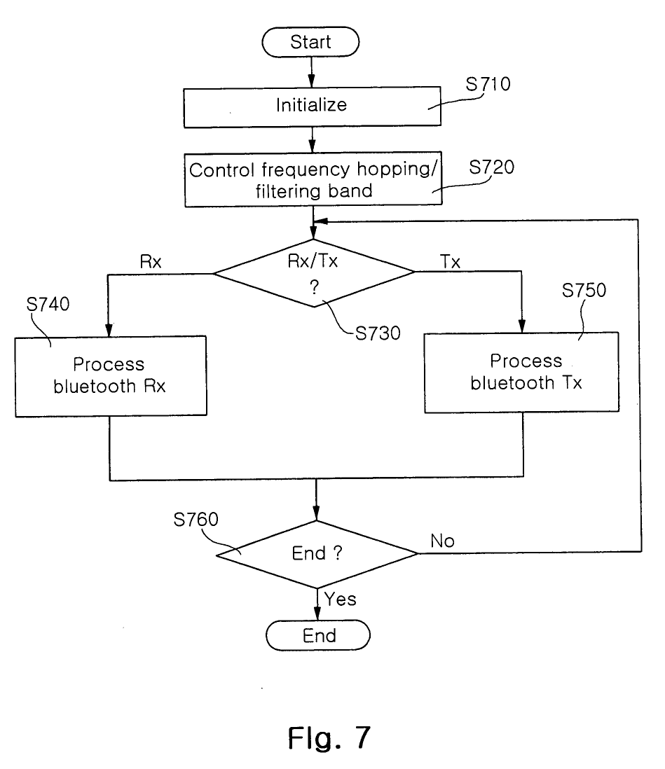

FIG. 6 shows a flowchart of signal processing in Zigbee operation mode of the invention and FIG. 7 shows a flowchart of signal processing in Bluetooth operation mode of the invention.

The transceiver for Zigbee and Bluetooth communications of the invention as shown in FIG. 6 and FIG. 7 performs transmitting and receiving process by operation mode, which will be explained hereunder.

Referring to FIG. 3 or FIG. 6, Zigbee operation mode will be described.

First, if Zigbee operation mode is selected, the main controller 160 of FIG. 3 executes initialization of loading the first firmware from the memory 140 (S610 of FIG. 6).

Next, the main controller 160 executes RF operation control (CRF) with the channel selection/frequency hopping controller 170, and the filtering band control with the variable bandpass filter 120.

The channel selection controller 171 of the channel selection/frequency hopping controller 170, under RF operation control (CRF) of the main controller, controls Zigbee channel selection for channel tuning over the RF processor 110 in case of selecting Zigbee operation mode (S620 of FIG. 6).

Then, the transceiver for Zigbee and Bluetooth communications of the invention, according to selection of Zigbee reception (Rx) or transmission (Tx) (S630 of FIG. 6), performs Zigbee receiving (Rx) operation (S640 of FIG. 6) or Zigbee transmitting (Tx) operation (S650 of FIG. 6), repeating the Zigbee receiving (Rx) or Zigbee transmitting (Tx) operation until its completion (S660 of FIG. 6).

Further, Zigbee receiving (Rx) operation will be explained hereunder.

Referring to FIG. 3, the RF processor 110 converts the RF reception signal corresponding to the channel selected under the control of the channel selection controller 171, out of 2.4 GHz RF reception signals from antenna ANT, into the IF reception signal to output to the variable bandpass filter 120.

In greater detail, the frequency synthesizer 111 of the RF processor 110, under the control of the channel selection/frequency hopping controller 170, executes channel selection, while the receiving processor 112 of the RF processor converts the RF reception signal corresponding to the channel selected by the frequency synthesizer 111 into the IF reception signal in Zigbee operation mode.

The variable bandpass filter 120 sets the first passband under the filtering band control (CFT) of the main controller 160, and passes the IF reception signal from the RF processor 110 through the set first bandpass to the FSK modulator/demodulator 130. The first passband is set at 5 MHz as a channel width of Zigbee.

The band pass filter can be implemented with a reconfigurable analogue filter, and with a digital filter such as a Finite Impulse Response (FIR) filter or an Infinite Impulse Response (IIR) filter. For example, FIG. 4 shows implementation of the bandpass filter via the FIR filter.

As shown in FIG. 4, the variable bandpass filter 120 comprises a delayer 121, a multiplier 122, a summer 123 and a coefficient controller 124. The coefficient controller 124, under the filtering band control (CFT), sets different coefficients for Zigbee and Bluetooth and provides the same to the summer 123. The plural delayer elements of the delayer 121 delay input signals stepwise to output to the multiplier 122. The plural multipliers of the multiplier 122 multiply each signal from the plural delayer elements of the delayer 121 by coefficients from the coefficient controller 124 to output. The summer 123 sums signals from the plural multiplier elements of the multiplier 122.

According to setting of coefficients, the first passband can be set at 5 MHz and the second passband at 1 MHz, which are all applied to Zigbee operation mode and Bluetooth operation mode of the invention.

Moreover, the variable bandpass filter 120 of the invention can be implemented by employing the known analogue filter or digital filter, the details of which will not be described further.

The FSK modulator/demodulator 130 FSK-demodulates the IF reception signal from the variable bandpass filter 120 into the baseband reception signal to output to the baseband processor 150.

The baseband processor 150, in response to the memory 140 executing the first firmware, converts the baseband reception signal from the FSK modulator/demodulator 140 into the digital reception signal by baseband processing to transmit to the main controller 160.

In more detail, as shown in FIG. 5, the baseband controller 151 of the baseband processor receives operation mode selection information (MS) from the main controller 160, and executes the first firmware of the memory 140 corresponding to the selected Zigbee operation mode to control receiving operation in accordance with Zigbee communication protocol (IEEE 802.15.4).

The Zigbee baseband processor 152 of the baseband processor 150, under the control of the baseband controller 151, processes Zigbee baseband reception signal. For Zigbee baseband processing, the reference table of the memory 140 is taken into account to perform a remapping process in response to a mapping of a corresponding transmitter to restore the reception signal into raw data.

Further, the main controller 160 controls receiving operation of Zigbee and executes higher layer processing of the digital reception signal from the baseband processor 150. Higher layer processing means processing data in an MAC layer, a network layer and an application layer in accordance with Zigbee communication protocol (IEEE 802.15.4).

Then, Zigbee transmitting (Tx) operation will be explained hereunder.

Referring to FIG. 3, the main controller 160 controls transmitting operation of Zigbee and processes the digital transmission signal at the higher layer to output to the baseband processor 150. Higher layer processing, as stated above, means processing data at an MAC layer, a network layer and an application layer in accordance with Zigbee communication protocol (IEEE 802.15.4).

The baseband processor 150, in response to the memory 140 executing the first firmware, converts the digital transmission signal from the main controller 160 into the baseband transmission signal to transmit to the FSK modulator/demodulator 140.

In more detail, as shown in FIG. 5, the baseband controller 151 of the baseband processor 150 receives operation mode selection information (MS) from the main controller 160, and executes the first firmware of the memory 140 corresponding to the selected Zigbee operation mode to control data transmitting operation in accordance with Zigbee communication protocol (IEEE 802.15.4). The Zigbee baseband processor 152 of the baseband processor 150, under the control of the baseband controller 151, executes Zigbee baseband processing. For Zigbee baseband processing, the reference table of the memory 140 is taken into account to perform a mapping process in response to a remapping of a corresponding transmitter to convert raw data into the transmission signal.

The FSK modulator/demodulator 130 FSK-modulates the baseband transmission signal into the IF transmission signal to output to the variable bandpass filter 120.

The variable bandpass filter 120, under the filtering band control of the main controller 160, sets the first passband, and outputs the IF transmission signal from the FSK modulator/demodulator 130 through the first bandpass to the RF processor 110. The first passband, as set forth above, is set at 5 MHz as a channel width of Zigbee.

The RF processor 110, under the control of the channel selection controller 171, converts the IF transmission signal from the variable bandpass filter 120 into the RF transmission signal according to channel selection under the control of the channel selection controller 171 to transmit via antenna ANT. In greater detail, the frequency synthesizer 111 of the RF processor 110, under the control of the channel selection/frequency hopping controller 170, selects a channel. The transmitting processor 113 of the RF processor 110 processes RF transmission signal via the channel selected by the frequency synthesizer 111 in Zigbee operation mode.

Referring to FIG. 3, 5 and 7, Bluetooth operation mode will be explained hereunder.

First, if Bluetooth operation mode is selected, the main controller 160 of FIG. 3 executes initialization of loading the second firmware from the memory 140 (S710 of FIG. 7).

Next, the main controller 160 executes RF operation control (CRF) via the channel selection/frequency hopping controller 170, and the filtering band control (CFT) via the band variable filter 120.

A hopping frequency controller 172 of the channel selection/frequency hopping controller 170, under the RF operation control of the main controller 160, controls frequency hopping in the RF processor 110 according to frequency hopping of the FSK modulator/demodulator 130 in case of selecting Bluetooth operation mode.

The transceiver of the invention, according to selection (S730 of FIG. 7) of Bluetooth reception or transmission, executes Bluetooth receiving operation (S740 of FIG. 7) or Bluetooth transmitting operation (S750 of FIG. 7), repeating Bluetooth receiving or transmitting operation until its completion (S760 of FIG. 7).

Then, Bluetooth receiving (Rx) operation will be described hereunder.

Referring to FIG. 3, the RF processor 110 converts 2.4 GHz RF reception signal from antenna ANT into the IF reception signal according to frequency hopping by the hopping frequency controller 172 to output to the variable bandpass filter (120).

In more detail, the frequency synthesizer 111 of the RF processor 110, under the control of the channel selection/frequency hopping controller 170, executes frequency hopping. The receiving processor 112 of the RF processor 110 converts the RF reception signal into the IF reception signal according to frequency hopping by the frequency synthesizer 111 in Bluetooth operation mode.

The variable bandpass filter 120, under the filtering band control (CFT) of the main controller 160, sets the second pass band, and passes the IF received signal from the RF processor 110 through the second bandpass set to the FSK modulator/demodulator 130. The second passband is set at 1 MHz as a channel width of Bluetooth.

The FSK modulator/demodulator 130 FSK demodulates the IF reception signal from the variable bandpass filter 120 into the baseband reception signal to output to the baseband processor 150.

The baseband processor 150, in response to the memory 140 executing the second firmware, processes the reception signal from the FSK modulator/demodulator 140 to transmit to the main controller 160.

In greater detail, as shown in FIG. 5, the baseband controller 151 of the baseband processor 150 receives operation mode selection information (MS) from the main controller 160, and executes the second firmware of the memory 140 corresponding to the selected Bluetooth operation mode to control data receiving operation in accordance with Bluetooth communication protocol (IEEE 802.15.1). The Bluetooth baseband processor 153 of the baseband processor 150, under the control of the baseband controller 151, executes Bluetooth baseband processing. With respect to baseband processing of Bluetooth, to correct errors in response to a channel encoding of a corresponding transmitter, a channel decoding process is performed for the reception signal.

Then, the main controller 160 controls Bluetooth receiving operation and executes higher layer processing of data received from the baseband processor 150. Higher layer processing means processing data at an MAC layer, a network layer and an application layer in accordance with Bluetooth communication protocol (IEEE 802.15.1).

Further, Bluetooth transmitting (Tx) operation will be described hereunder.

As shown in FIG. 3, the main controller 160 controls Bluetooth transmitting operation and executes higher layer processing of transmission data to output to the baseband processor 150. Higher layer processing means processing data at an MAC layer, a network layer and an application layer in accordance with Bluetooth communication protocol (IEEE 802.15.1).

The baseband processor 150, in response to the memory 140 executing the second firmware, processes the transmission signal from the main controller 160 to transmit to the FSK modulator/demodulator 140.

In greater detail, as shown in FIG. 5, the baseband controller 151 of the baseband processor 150 receives operation mode selection information (MS) from the main controller 160 and executes the second firmware of the memory 140 corresponding to the selected Bluetooth operation mode to control data transmitting operation in accordance with Bluetooth communication protocol (IEEE 802.15.1). The baseband processor 153 of the baseband processor 150, under the control of the baseband controller 151, executes Bluetooth baseband processing. With respect to Bluetooth baseband processing, to correct errors in the receiver, a channel encoding process is performed for the reception signal in response to the channel decoding process.

The FSK modulator/demodulator 130 FSK-modulates the baseband transmission signal from the baseband processor 150 into the IF transmission signal to output to the variable bandpass filter 120.

The variable bandpass filter 120, under the filtering band control (CFT) of the main controller 160, sets the second passband, and outputs the IF transmission signal from the FSK modulator/demodulator 130 to output to the RF processor 110. The second passband, as stated above, is set at 1 MHz as a channel width of Bluetooth.

The RF processor 110 converts the IF transmission signal from the variable bandpass filter 120 into the RF transmission signal according to frequency hopping by the hopping frequency controller 172 to transmit via antenna. In greater detail, the frequency synthesizer 110 of the RF processor 110, under the control of the channel selection/frequency hopping controller 170, executes frequency hopping. The transmitting processor 113 of the RF processor 110 converts the IF transmission signal from the variable bandpass filter 120 into the RF transmission signal according to frequency hopping by the frequency synthesizer 110.

As described above, the transceiver of the invention integrates a Zigbee transceiver and a Bluetooth transceiver so as to partially make common use of an higher layer application and a physical layer of the Zigbee transceiver and the Bluetooth transceiver. The invention has the advantage of functioning as a transceiver for Zigbee and Bluetooth communications without causing a significant increase in size and unit price.

To implement functions of both Bluetooth and Zigbee, the invention employs 1 chip, not 2 chips. As a result, a pad for wire bonding, a buffer and a memory can be shared for use, leading to the advantage of decreasing price and size. Compared to a case where each function is implemented with 1 chip of simple parallel structure, the invention commonly uses a majority of receiving blocks so as to implement a transceiver sized similar to the prior art Bluetooth transceiver.

While the present invention has been shown and described in connection with the preferred embodiments, it will be apparent to those skilled in the art that modifications and variations can be made without departing from the spirit and scope of the invention as defined by the appended claims.

What is claimed is:

1. A transceiver for Zigbee and Bluetooth communications comprising:
an RF processor for converting an RF signal received via antenna into an IF reception signal under channel selection/frequency hopping control;
a variable bandpass filter for passing the IF reception signal from the RF processor through a first passband or a second passband, which is pre-set under filtering band control;
an FSK modulator/demodulator for FSK-demodulating the IF reception signal from the variable bandpass filter into a baseband reception signal;
a memory storing a first firmware and a reference table for Zigbee operation mode, and a second firmware for Bluetooth operation mode;
a baseband processor for converting the baseband reception signal from the FSK modulator/demodulator into a digital reception signal in response to the memory executing a corresponding one of the firmwares according to a selected operation mode;
a main controller for executing signal transmission/reception control for the selected operation mode including the filtering band control and RF operation control, in response to the memory executing a corresponding one of the firmwares according to the selected operation mode, and processing the digital reception signal from the baseband processor and a digital transmission signal at a higher layer; and
a channel selection/frequency hopping controller for executing channel selection control or frequency hopping control over the RF processor in response to the RF operation control by the main controller,
whereby the baseband processor converts the digital transmission signal from the main controller into a baseband transmission signal,
the FSK modulator/demodulator converts the baseband transmission signal from the baseband processor into an IF transmission signal,
the variable bandpass filter passes the IF transmission signal from the FSK modulator/demodulator through the pre-set passband, and
the RF processor converts the IF transmission signal from the variable bandpass filter into an RF transmission signal to output via the antenna.

2. The transceiver for Zigbee and Bluetooth communications according to claim 1, wherein the RF processor comprises:
a frequency synthesizer for executing channel selection or frequency hopping under the control of the channel selection/frequency hopping controller;
a receiving processor for converting the RF reception signal corresponding to a channel selected by the frequency synthesizer into the IF reception signal in Zigbee operation mode, and converting the RF reception signal into the IF reception signal according to frequency hopping by the frequency synthesizer in Bluetooth operation mode; and
a transmitting processor for converting the IF transmission signal from the variable bandpass filter into the RF transmission signal corresponding to the channel selected by the frequency synthesizer in Zigbee operation mode, and converting the IF transmission signal from the variable bandpass filter into the RF transmission signal according to frequency hopping by the frequency synthesizer in Bluetooth operation mode.

3. The transceiver for Zigbee and Bluetooth communications according to claim 1, wherein the first passband is set at 5 MHz as a channel width of Zigbee, and the second passband is set at 1 MHz as a channel width of Bluetooth.

4. The transceiver for Zigbee and Bluetooth communications according to claim 1, wherein the baseband processor comprises:
a baseband controller for receiving operation mode selection information from the main controller and executing a corresponding one of the firmwares of the memory according to the selected operation mode to control transmitting or receiving operation corresponding to the selected mode;
a Zigbee baseband processor operating under the control of the baseband controller; and
a Bluetooth baseband processor operating under the control of the baseband controller.

5. The transceiver for Zigbee and Bluetooth communications according to claim 1, wherein the channel selection/frequency hopping controller comprises:
a channel selection controller for controlling Zigbee channel selection over the RF processor in Zigbee operation mode, under the RF operation control by the main controller; and
a frequency hopping controller for controlling frequency hopping over the RF processor in response to frequency hopping of the FSK modulator/demodulator in Bluetooth operation mode.
